(19) United States
(12) Patent Application Publication
(10) Pub. No.: US 2001/0049612 A1
(43) Pub. Date: Dec. 6, 2001

(54) Survivor's benefit plan

(75) Inventor: Philip T. Davis, Danbury, CT (US)

Correspondence Address: Mr. Richard H. Zaitlen, PILLSBURY WINTHROP LLP, Suite 2800, 725 South Figueroa Street, Los Angeles, CA, 90017, US

(73) Assignee: Corporate Compensation Plans, Inc.

(21) Appl. No.: 09/853,566

(22) Filed: May 10, 2001

Related U.S. Application Data
(60) Provisional application No. 60/203,521, filed on May 10, 2000.

(51) Int. Cl. G06F 17/60

(52) U.S. Cl. 705/4

(57) ABSTRACT

A method for providing deferred compensation to an employee's beneficiary is disclosed, whereby the benefit takes the form of insurance policy proceeds payable to an employee's beneficiary, and wherein the deferred compensation is paid to the beneficiary in an income and estate tax free manner.

### BACKGROUND OF THE INVENTION

1. Field of the Invention

This invention relates in general to deferred compensation arrangements, and in particular embodiments, to methods for providing deferred income and estate tax-free survivorship payments from Non-Qualified Deferred Compensation Plans without an increased cost to the employer.

2. Description of Related Art

In deferred compensation arrangements, an employer agrees to compensate an employee for the employee's present services at agreed-upon date(s) in the future. The employee elects to defer certain contribution amounts from current income under the deferred compensation arrangement. In some arrangements, interest and/or investment returns may accrue on the total amount of these contribution amounts under the deferred compensation arrangement.

Non-qualified deferred compensation (“NQDC”) plans are an increasingly popular method of compensating key employees in both publicly held and private companies. One significant reason for this popularity is that non-qualified deferred compensation plans are not subject to the Internal Revenue Code (IRC) requirements relating to maximum coverage and contribution limitations which apply to qualified deferred compensation plans. Examples of such IRC qualified deferred compensation requirements include a limit on the amount of employee income used to calculate deferred compensation, a limit on the amount of income that may be deferred by the employee, and limitations based on the amounts or percentage of income that other employees are deferring at the same time.

Another reason for the popularity of non-qualified deferred compensation plans is that such plans generally avoid certain compliance restrictions imposed under the Employee Retirement Income Security Act of 1974 (“ERISA”), as amended. ERISA contains rules governing employer-sponsored benefit plans. Exemptions to ERISA compliance relating to contribution limitations arise in unfunded compensation plans created “primarily for the purpose of providing deferred compensation for a select group of management or highly compensated employees.” Other qualified deferred compensation arrangements are generally included under the ERISA laws.

One common concern of employees participating in non-qualified deferred compensation plans is the tax that must be paid to the Internal Revenue Service when the deferred compensation is paid to the employee. Generally, the employee must pay income tax on the deferred compensation, even if the deferred compensation is paid to the employee's estate upon the employee's death. The deferred compensation is also subject to estate tax when the employee dies if it is part of the employee's estate upon his death, whether the compensation was paid to the employee during his lifetime or to his estate upon his death. However, this double tax is somewhat alleviated when the deferred compensation is paid to an employee at the employee's death. When deferred compensation is paid as income to a decedent, the IRS allows the estate to deduct any estate tax paid from the income tax that is due on the income. The deduction amount is determined by comparing the estate tax paid with the amount of estate tax that would have been paid had the income payable to the decedent not been included in the estate.

Non-qualified deferred compensation plans are somewhat risky for the employee. The benefit is at risk of forfeiture should the employer breach its promise to pay, or be unable to pay, the promised sums. Further, if the employer becomes insolvent, there is a risk that the employee may not be able to access the deferred compensation prior to creditors of the employer. Creditor exemptions available under ERISA do not apply to non-qualified deferred compensation plans.

One method commonly used to provide assurances to the employee that the benefits and any interests and gains will be available when due to the employee is to place the deferred compensation in an irrevocable trust for the benefit of the employee. This is commonly referred to as a Rabbi Trust. While the assets of the trust are restricted for uses other than payment of the benefits agreed upon, the trust assets are subject to the claims of the company's creditors if the company becomes insolvent.

The use of corporate owned life insurance (COLI) is another method used to provide greater assurance that the benefits will be available when due to the employee. Under COLI, the employer is the owner and the beneficiary of the policy. The policy accumulates a cash value over time to pay the benefits owing to the employee at some later date. This method is also subject to creditor's claims, since the cash value and death benefits remain in the control of the employer.

If an employer provides unfunded nonqualified deferred compensation arrangements for its employees, the employer must create bookkeeping accounts to measure the amount owed to employees. Such accounts are generally referred to as accrual accounts, and are carried on the employer's financial statements as a direct liability. As such, the deferred compensation has the effect of reducing the employer's net worth.

It is desired to have a non-qualified deferred compensation arrangement that provides the safest maximum benefit to the employee, and the minimum expense or detriment to the employer.

### BRIEF DESCRIPTION OF THE DRAWINGS

A detailed description of embodiments of the invention will be made with reference to the accompanying drawings:

FIG. 1 is a flowchart according to one embodiment of the present invention illustrating a method for providing deferred compensation in a manner that provides a net benefit to both the employer and employee; and

FIG. 2 provides an example of the benefits that can be achieved through one embodiment of the present invention.

### DETAILED DESCRIPTION OF THE PREFERRED EMBODIMENTS

As shown in the drawings, which are provided for the purpose of illustration only, embodiments of the present invention include a method of paying deferred compensation to the beneficiary or beneficiaries of an employee in a manner that provides a benefit to both the employee and the employer. The employee benefits by having the deferred compensation paid to his/her beneficiary in a manner that does not incur (or reduces) either income or estate tax. As such, the employee's beneficiary receives a higher percentage of the deferred compensation, which is much closer to the amount of deferred compensation originally designated as such by the employer and employee. Since providing money to the employee's beneficiaries in the form of survivor's benefits is one purpose of deferred compensation arrangements, the receipt of an increased amount of money by the beneficiaries is perceived as an increased benefit to the employee.

The employer benefits under the present invention by being released by the employee from the obligation to pay survivor's benefits. This release is a benefit, since it is reflected as a net reduction in liability on the company's balance sheet. Such a liability is seen as a charge against earnings. As such, a reduction in the liability results in an increase in employer earnings. In one embodiment of the present invention such profits may be used by the employer to fund the purchase of the insurance plan on behalf of the employee.

The employer also benefits from the employee goodwill that results from the employer offering a deferred compensation plan that provides income and estate tax free deferred income to the employee's survivors. Employees will undoubtedly be pleased to know that what heretofore had been provided as taxable monies to their survivors will now be provided in an income and estate tax-free manner. As such, the employee's survivor will receive a greater net amount of the deferred compensation. A further benefit of the present invention is that this mutual benefit may be achieved at no additional cost to the employer.

The method of the present invention may be achieved utilizing the computer system according to an embodiment of the present system. The computer system includes at least one computer terminal, which in turn includes a monitor, computer and data input means. Such input means may include, but are not limited to, a keyboard, a modem (or similar access provider, such as a T-1 line), a scanner, a floppy disk reader, a CD scanner, and the like. The computer is equipped with specialized software that is designed to facilitate the purchasing, and maintaining of the insurance policies. Such specialization allows the user to select an insurance policy that best suits the employer and employee needs. The software program according to one embodiment of the present invention may include: a data input module, a program database, a processing module, an insurance plan selection module, a fee calculation module, an enrollment and administration module, a word-processing module and, optionally, a payment module.

It should be understood by one skilled in the art that the selection of appropriate modules to satisfy the software requirements of the present is system-specific. A system may be designed to specialize so that it performs only a portion of the functions performed by the modules listed above. In such a system, one or more modules may be unnecessary. It should be further understood that the differentiation between modules is for ease of explanation only, and one module may perform the functions delineated herein as being performed by a separate module.

The modem or other feature that accepts and transfers information to and from remote locations is useful to allow employers and employees to remotely set up their accounts, access their accounts, and request changes thereto. The modem or other similar feature also allows the provider to provide and promote its services on an Intranet, the Internet, the World Wide Web, or other similar linked system. The services may be provided on the such a linked system in that an employer may enroll online, make payments electronically (though, of course, these payments may also be sent via more traditional means, such as through the mail), and revise the employer's accounts with the provider. The employee may also access such a site to check on the account whose proceeds will pass to his beneficiaries.

As noted above, the computer is equipped with specialized software that is designed to facilitate the purchasing, and maintaining of the insurance policies. This software may be designed to provide the user with a range of insurance policies that may suit the Employer's needs based on cost, coverage, and overall benefits. For example, the user may utilize the software to initiate electronic contact with another database(s) so that rates and insurance policies may be determined. This allows the user to view a range of insurance plan options, and choose the one that best suits the Employer's needs. Alternatively, the insurance plan information may be obtained from insurance company publications.

As noted above, the software according to one embodiment of the present invention may include a data input module, a program database, an insurance plan selection module, a calculation module, an enrollment and administration module, a word-processing module and, optionally, a payment module. The data import module may be used to import information including but not limited to data pertaining to the employee, data pertaining to the employer, and data pertaining to insurance plans.

The program database contains information that is imported through the data import module and information that is generated within the system. Information that is generated within the system may include, for example, client file information, dates of activity, and a record of which insurance plan was selected and what the associated fees are.

The insurance plan selection module selects an insurance plan either from those stored in the program database or from an outside database that may be accessed by the computer system. This selection may be based on a number of different criteria including, but not limited to: the amount of the survivor's benefit intended, the health of the employee, and the age of the employee.

The enrollment and administration module, which may be coupled to the payment module, may be used to track customers of the plan who seek to have plan administrators oversee their employees' policies. This module may handle customer accounts, and periodically update the systems records so that the record of those policies that each employer wishes to maintain, and those which the employer wishes to allow to lapse, is kept current. The module may also provide data to the system administrator in the form of pie charts, graphs, and/or tables. Such data may include, but is not limited to, summaries of information input into the system, summaries of the system's output, profitability information, and client information.

The payment module, which may be incorporated in the enrollment and administration module, tracks those accounts that are administered by the system administrator. In this fashion, the administrator can inform the employer and/or employee if any payments are missed, or if the amount of payment changes for any reason. Alternatively, the system may be designed to electronically make the payments for the employer, and bill the employer for these amounts periodically.

The calculation module, which may be incorporated within the payment module, may be used to calculate the fee to be charged for the selected insurance policy. The fee schedule may be provided to the calculation module in the form of a mathematical algorithm. Alternatively, the fee may be provided in the form of a fee schedule based on a number of variables. Alternatively, or additionally, the calculation module may calculate the fees that each employer will be charged for the deferred compensation services. Such fee includes the amount of any insurance plan as well as the fee associated with the services charged by the system administrator for setting up the insurance plan and providing the survivor's benefit.

In one embodiment of the present invention, the calculation module may also be used to calculate projected reductions in employer liability and related increase in employer assets. This feature is particularly useful for demonstrate the actual reduction in company liabilities to the employer.

The word-processing module may be used to generate brochures and/or other literature about the survivor's benefit plan. It may also be used to generate notices relating to a particular plan for the employer and/or employee.

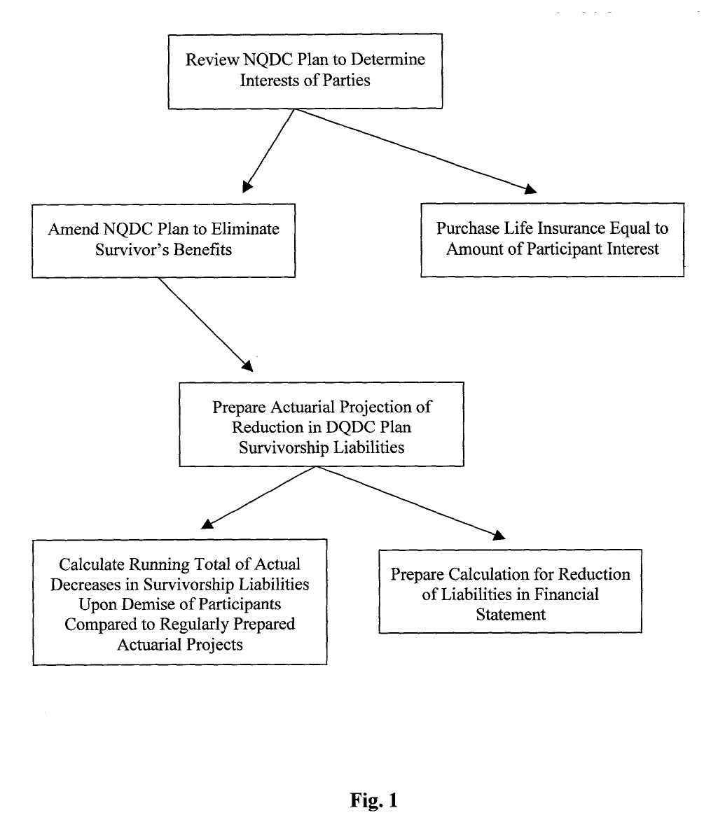

As shown in FIG. 1, one embodiment of the present invention begins with a review of a presently existing non-qualified deferred compensation (NQDC) plan, or supplemental executive retirement plan, to determine the amount of survivor's benefits currently owing to the employee. Alternatively, the employer and employee may come to a new arrangement regarding the amount of survivor's benefits to be paid. Next, a life insurance policy having a benefit amount approximately equal to the predetermined benefit amount is selected. This selection may be done by the employer, the employee, both of them, or even by a third party.

This life insurance policy will have a premium that must be paid with after-tax dollars. The employee or a third party may fund this premium. If the employer chooses to provide the funds for the premium, it may provide this funding to a third party or other entity, who may then purchase the policy. The party who paid the premium is the owner of the policy. However, it should be noted that, if the employee pays the premium, the policy proceeds may be subject to estate tax. In some instances, it may be preferable to have an irrevocable life insurance trust as the life insurance policy owner.

The life insurance policy may be Group Term life insurance, Individual term life insurance, Split dollar life insurance, or individual variable life insurance.

In an alternate embodiment of the present invention, the amount of benefits desired by the participant and the participant's employer to be paid to the participant's survivor is first determined. This first step is taken primarily when the amount of a NQDC plan has not yet been determined, or when it is subject to change.

As shown in FIG. 1, once the decision has been made to provide survivor's benefits under the present invention instead of through traditional methods, the NQDC plan should be amended to eliminate survivor's benefits. The employer may then calculate a reduction in plan survivorship liabilities, and prepare an actuarial projection of this reduction. Survivorship liabilities are the amounts that the employer keeps on its books that are payable to the beneficiaries of deceased employees. Since these amounts are carried as liabilities, the reduction of this amount has the net effect of increasing the net worth of the employer by reducing survivorship liabilities carried on a company's financial statement. The benefit of the present invention may be seen by calculating a running total of actual decreases in survivorship liabilities upon the demise of plan participants.

Under the present invention, the insurance premium is paid with deferred employee compensation. Employee compensation which may be used to pay the premium may be defined as virtually anything of value the employee receives from the employer including, but not limited to, employee benefits, vacation time, salary, or employer-paid defined contribution matches. Alternatively, the employee or employer may fund the insurance premiums from their own funds. While the employer may to fund the insurance premium, the actual purchasing of the plan and premium payment must be done by some third party in order to qualify for the minimized tax of the present invention. Such funding by the employer of the insurance premiums will be viewed as compensation that the employer would have provided, in one form or another. This will therefore also be included in the term “employee compensation.”

If the funding for the insurance policy comes from employee compensation as defined above, employee compensation will have to be withheld by the employer or otherwise deducted from the employee's benefits. In order to determine the amount of employee compensation that is required to be paid by the employee, a pre-tax amount of employee compensation must be determined, the post-tax amount of which is roughly equivalent to the post-tax amount of the insurance premium. The employee must agree to forfeit a reduction from the amount due from the employer in a pre-tax amount that is roughly equivalent to the post-tax amount of the insurance premium. This forfeiture must be continuous; that is, the employee must continue to forfeit the pre-tax value of the post-tax premium amount on a regular basis as the premiums become due. However, the type of employee compensation which is forfeited to pay the insurance premiums may vary throughout the life of the plan.

Alternatively, the value of a benefit due to the employee may be reduced in an amount equal to the value of the insurance policy. For example, if the insurance policy has a $10,000 premium, the employee could agree to a reduction in salary in the amount of $10,000. However, the employee will still have to pay income tax on the amount of the premium, as it will be considered imputed income or compensation to the employee.

In one embodiment of the present invention, the employee must release the employer from the obligation to pay the amount of survivor's benefits that are currently provided to the employee. The employer is released from the obligation to pay future survivor's benefits, and is responsible for payment of the insurance premium on a continuing basis. In this manner, the existing survivors benefits are exchanged for the survivors benefits in the form of the insurance proceeds. In an alternate embodiment of the present invention, the survivor's benefits that have accrued, but have not yet been paid to the employee, may be forfeited by the employee in favor of the employer. In such a situation, it is expected that the employer would either fund the insurance plan in full or in part itself.

To qualify for the tax benefits of the present invention, virtually any entity, other than the employee, may be named as the beneficiary of the insurance policy under the present invention. By way of example, and not of limitation, a survivor or survivors, a trust, a deferred compensation plan, a foundation, a charitable remainder trust, a third party, the employer (though in this situation the policy may be subject to the employer's creditors) or any combination of the above may named as a beneficiary of the insurance policy. In this manner, the “deferred compensation” may be paid on the employee's death to the employee's beneficiary in the form of proceeds from an insurance policy. That is, any proceeds from the policy that have not previously been paid to the employee during his lifetime may be paid to his beneficiaries in the form of proceeds from an insurance policy. The payment of the proceeds of the policy to the beneficiary, and not the decedent, is an important aspect of the present invention, since payments which may be made to a decedent are considered part of the gross estate and are subject to estate tax. See IRC § 2039.

As noted above, it should be realized that the employee may “cash out” the policy during his lifetime. For example there may come a time when the employer and/or employee decides to stop paying premiums on the policy. Alternatively, the policy may be designed to pay out certain amounts at certain times, for example one tenth of the value of the policy payable each year over ten years starting at age sixty-five. If the employee receives any pay out from the policy during his lifetime, the employee will incur some taxation on the money he or she receives. Any unpaid amounts will be paid to the employee's beneficiary.

This invention provides several benefits to the employer. First, the employer benefits from the reduction in the amount of survivor's benefits liabilities that it must keep on its books as a liability. Generally, unfunded amounts due to an employee's beneficiaries are tracked in bookkeeping accounts. These accounts are referred to as accrual accounts, and carried on the employer's financial statements as a direct liability. This may be viewed as detrimental to the employer, since carrying the amounts owed to employees on the employer's fmancial statements as a direct liability has the effect of reducing the employer's net worth.

Secondly, the employer benefits from the employee goodwill that results from the employer offering a deferred compensation plan that provides income and estate tax free deferred income to the employee's survivors. Employees will undoubtedly be pleased to know that what heretofore had been provided as taxable monies to their survivors will now be provided in a manner which reduces or eliminates income and estate taxes. As such, the present invention provides a greater net amount for the employee's survivors. As such, it has the same net effect as an increase in survivor's benefits would have had.

The employee also receives additional benefit from the present invention. As noted above, the present invention provides the same amount of benefit to the employee's survivors, but the benefit is provided in an income and estate tax-free manner. As such, the employee's beneficiaries receive a greater amount of the benefit. As far as the employee and the employee's beneficiaries are concerned, the present invention has the same net effect as a substantial increase in deferred compensation.

The present invention also arguably provides some additional security to the employee and the employee's beneficiaries. While the creditor exemptions available under ERISA do not apply to non-qualified deferred compensation plans, under the present invention, the policy owner is neither the employer nor the employee, thus the insurance policy is not subject to the employer or employee's creditors. As such, there is no concern on the part of the employee's beneficiaries, or the employee, that creditors might try to attach the deferred compensation should the employer or employee become insolvent.

Taxation Upon Distribution Many nonqualified deferred compensation plans permit the designation of a beneficiary to receive the proceeds of the non-qualified deferred compensation plan upon the death of the employee. Such an arrangement is subject to taxation under IRC § 2039, and the proceeds are included in the employee's gross estate for purposes of federal income taxation. Such employer-financed death benefits, which have survivorship features, are analyzed in the same manner as deferred compensation is analyzed, since they constitute a promise to pay sums to beneficiaries upon the death of an employee.

The present invention, in contrast, is not such an arrangement whereby an employer accrues benefits payable as a death benefit to a designated beneficiary. The present invention provides a benefit to the employee's beneficiary in the form of proceeds from a life insurance policy. The proceeds of an insurance policy on the life of the decedent are thus not taxable under IRC § 2039.

Other sections of the IRC, which shall not be enumerated here, govern the taxation of death benefits derived from deferred compensation plans. However, none of them provide for taxation of the present invention.

The present invention avoids the restrictions imposed under the Internal Revenue Code applicable to the taxation of proceeds derived from qualified employee benefit plan payments. The present invention permits insurance policy proceeds to be paid to the beneficiary(ies) of an employee net of the tax.

Estate Taxation

Under the present invention, deferred compensation is not subject to estate tax by the Internal Revenue Service. Estate taxation of life insurance requires that the beneficiary possess incidents of ownership of the insurance policy. If an incident of ownership exists, the policy is included in the estate of the decedent. Under IRC § 2042, incidents of ownership include the power to: (1) influence the economic benefit of the policy, including the power to change the beneficiary; (2) surrender or cancel the policy; (3) assign the policy; (4) revoke an assignment of the policy; (5) pledge the policy for a loan; and (6) obtain a policy loan. Since deferral accounts, such as those usually provide by employers for employees' deferred compensation, usually have some incidents of ownership, they are usually subject to estate taxation. The same rule applies to insurance policy proceeds that are payable to the estate of the insured.

The present invention, in contrast, does not have any incidents of employee ownership. The life insurance policy is bought by a third party and paid for by a third party. The funding may come from compensation that the employee has not yet received, such as deferred compensation, employee benefits, vacation time, salary, or employer paid defined contribution matches. Such forms of payment serve to decrease the accrued liability of the employer. Alternatively, the funding could come directly from the employee or the employer. The beneficiary of the employee holds all incidents of ownership from the issuance of the policy. The incidents of ownership therefore are not held by the employee, and will not be included in his estate.

Income Taxation

Generally, if one does not utilize the present invention, money paid to designated beneficiaries from non-qualified deferred compensation plans are classified by the Internal Revenue Service as “income in respect to a decedent” (IRD). IRD is that money that the decedent was entitled to as gross income, but which was not may not be included in his taxable income for the year of his death. The estate or beneficiary receiving IRD will pay tax on the income in the same manner as the decedent would have paid tax on the income, had he not become deceased.

In contrast, under the present invention, the proceeds of the life insurance policy that are payable to the designated beneficiary are not subject to income taxation. Since the present invention eliminates survivorship rights in the deferral account, the use of the present invention avoids the deferred compensation being viewed as IRD.

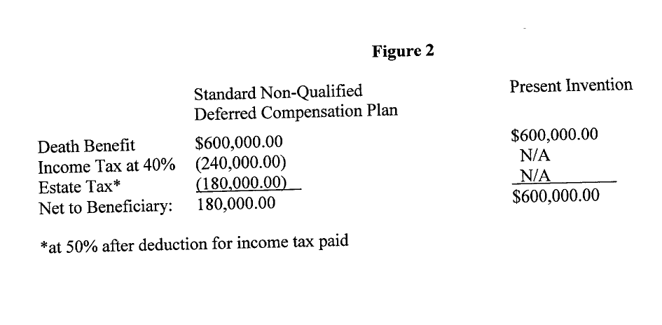

As may be seen from FIG. 2, the present invention provides a substantial increase in net benefit to the beneficiaries. By comparing the amounts received by beneficiaries under traditional deferred compensation plans, and the amount received by beneficiaries if one utilizes the present invention, it is clear that utilization of the present provides a greater monetary benefit to employees' beneficiaries than traditional survivor's benefit plans.

As may be seen from the illustration of a standard non-qualified deferred compensation plan in FIG. 2, a death benefit of $600,000 may be subject to individual income tax and estate tax. For the purposes of this illustration, the individual tax rate of 40% is used. After deducting $240,000 for the individual income tax, estate tax is then deducted from the death benefit. For the purposes of this illustration, the estate tax rate of 50% is used. This results in a net benefit to the beneficiary of $180,000. In contrast under the present invention, the beneficiary would receive $600,000, since life insurance proceeds are not subject to individual and estate taxes.

It should be noted that, in some situations, death benefits are subject primarily only to individual income taxes. In such a situation, the beneficiary of a standard nonqualified deferred compensation plan would receive $360,000.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A method for providing survivor's benefits to be paid to a designated beneficiary of a plan participant so that income tax and estate tax liability are minimized, thereby resulting in the receipt of a higher percentage of the benefits by the beneficiary, the method further producing a net reduction in liabilities for the employer, the method comprising the steps of:
determining an amount of survivors' benefits to be paid to the participant's designated beneficiary, wherein at least a portion of the determined benefits are existing survivors' benefits designated under a plan;
permitting the substitution of a life insurance policy for the determined benefits by the employee;
selecting the life insurance policy having a benefit amount approximately equal to the determined benefit amount;
determining the premium to be paid on behalf of the participant for the insurance policy having the selected benefit amount; calculating a before-tax value of a reduction in participant compensation such that an after-tax value of the reduction is approximately equal to the insurance policy premium;
deducting an amount from the participant's compensation equal to the insurance policy premium;
designating a beneficiary of the insurance policy,
paying on behalf of the participant of the insurance plan premium, wherein the paying is performed with participant compensation; and
entering the substitution of the life insurance policy for the determined benefits as a reduction in accrued employer liabilities on a balance sheet, wherein the selected insurance policy purchased on behalf of the participant, which is not subject to the employer's creditors, increases the survivor's benefits payable to the beneficiary.

2. The method of claim 1, wherein the amount of benefits is determined by the participant or the participant's employer.

3. The method of claim 1, wherein the plan is selected from the group consisting of a non-qualified deferred compensation plan and a supplemental executive retirement plan.

4. The method of claim 1, wherein the reduction in participant compensation is a reduction from a salary paid by the employer to the participant.

5. The method of claim 1, wherein the method may be performed at no additional cost to the employer.

6. The method of claim 1, wherein the determined benefits are greater than the existing survivors' benefits.

7. The method of claim 1, the method further including an elimination of an existing survivor's benefit.

8. The method of claim 1, further comprising the step of:
upon the death of the participant, receiving by the beneficiary a remaining benefit amount of the insurance policy on an income tax-free and estate tax-free basis.

9. The method of claim 8, wherein the amount received by the beneficiary is approximately equal to the pre-tax value of the survivor's benefits intended to be distributed by the participant and the employer.

10. A method for providing survivor's benefits to be paid to a designated beneficiary of a plan participant so that income tax and estate tax liability are minimized, thereby resulting in the receipt of a higher percentage of the benefits by the beneficiary, the method further producing a net reduction in liabilities for the employer, the method comprising the steps of:
reviewing an existing compensation structure to determine an amount of survivors' benefits currently provided;
permitting the substitution of the a life insurance policy for survivors' benefits by the employee;
calculating a reduction in plan survivorship liabilities caused by the substitution of a life insurance policy for survivors' benefits;
selecting the life insurance policy, wherein the life insurance policy has a benefit amount approximately equal to the predetermined benefit amount;
determining a premium to be paid by the employer for the insurance policy;
calculating a before-tax value of a reduction in employee compensation such that an after-tax value of the reduction is approximately equal to the insurance policy premium;
paying the insurance plan premium;
designating a beneficiary of the insurance policy; and
entering the substitution of the life insurance policy for survivors' benefits as a reduction in liabilities on a balance sheet,
wherein the method results in a net reduction in survivorship liabilities for the employer, and further wherein the selected insurance policy purchased on behalf of the employee, which is not available to the employee and employer's creditors, increases the survivors' benefits payable to the survivors of deceased participants.

11. The method of claim 10, wherein the plan is selected from the group consisting of a non-qualified deferred compensation plan and a supplemental executive retirement plan.

12. The method of claim 10, further comprising the step of agreeing by the parties to continued payment of the insurance plan premium.

13. The method of claim 10, further comprising the steps of:
upon the death of the participant, receiving by the beneficiary the benefit amount of the insurance policy on a minimized income tax and estate tax basis.

14. A method for providing survivor's benefits to be paid to a designated beneficiary of a plan participant without income tax and estate tax liability, thereby resulting in the receipt of a higher percentage of the benefits by the beneficiary, the method comprising the steps of:
reviewing an existing compensation structure to determine an amount of survivors' benefits currently provided;
determining an amount of benefits to be paid to the participant's survivor;
permitting the substitution of a life insurance policy for the survivors' benefits by the employee;
calculating a reduction in plan survivorship liabilities;
selecting a life insurance policy having a benefit amount approximately equal to the predetermined benefit amount;
determining an after-tax premium to be paid by the employer for the insurance policy having the selected benefit amount;
calculating a before-tax value of a reduction in employee compensation such that an after-tax value of the reduction is approximately equal to the premium;
paying of the insurance plan premium to purchase the life insurance policy, wherein the before-tax value of the reduction retained by the employer substantially offsets the after-tax premium paid by the employer such that that employer purchases the life insurance policy at substantially no cost to the employer;
designating the plan participant's survivor as a beneficiary of the insurance policy; and
entering the reduction in plan survivorship liabilities in a balance sheet as a net increase in assets,
wherein the method results in a net reduction in survivorship liabilities, and further wherein the selected insurance policy purchased by the employer, which is not subject to the employer's creditors, increases the survivor's benefits payable to the survivors of deceased participants.

15. The method of claim 14, wherein the plan is selected from the group consisting of a non-qualified deferred compensation plan and a supplemental executive retirement plan.

16. The method of claim 14, further comprising the step of agreeing by the parties to continued payment of the insurance plan premium.

17. The method of claim 14, further comprising the step of: upon the death of the participant, receiving by the beneficiary the benefit amount of the insurance policy on a minimal income tax and estate tax basis, wherein the amount received by the beneficiary is approximately equal to the pre-tax value of the survivor's benefits intended to by the participant and the employer to be distributed.

18. A method for structuring a compensation plan such that survivor's benefits are paid to a designated beneficiary of an employee in a manner that results in minimal income tax and estate tax liability, thereby resulting in the receipt of a higher percentage of the benefits by the beneficiary, the method further producing a net reduction in liabilities for the employer, the method comprising the steps of:
determining an amount of benefits to be paid to the employee's beneficiary;
permitting the substitution of a life insurance policy for the determined benefits by the employee;
selecting a life insurance policy having a benefit amount approximately equal to the determined benefit amount;
determining a premium to be paid for the insurance policy;
designating a payer to pay the premium for the insurance plan premium;
designating a beneficiary of the insurance policy;
paying by the payer of the insurance plan premium; and
entering the substitution of the life insurance policy for the determined benefits as a reduction in accrued employer liabilities on a balance sheet,
wherein the selected insurance policy, which is not subject to the employer's creditors, increases the survivor's benefits payable to the survivors of deceased participants.

19. The method of claim 18, wherein the amount of benefits is determined by the employee or the employee's employer.

20. The method of claim 18, wherein the method is performed at no additional cost to the employer.

21. The method of claim 18, the method further including the step of calculating a before-tax value of a reduction in employee compensation such that an after-tax value of the reduction is approximately equal to the after-tax premium.

22. The method of claim 21, the method further including the step of retaining by the employer the before-tax value of the reduction in employee compensation.

23. The method of claim 18, the method further including an elimination of existing survivors' benefits.

24. The method of claim 18, further comprising the step of:
upon the death of the participant, receiving by the beneficiary a remaining benefit amount of the insurance policy on an income tax-free and estate tax-free basis.
